(19) United States
(12) Patent Application Publication
(10) Pub. No.: US 2004/0261136 A1
(43) Pub. Date: Dec. 23, 2004

(54) Multi-media receiving device and multi-media receiving system

(75) Inventors: Shuntaro Aratani, Tokyo (JP); Takashi Yamamoto, Kanagawa (JP); Tetsu Fukuda, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/868,857

(22) Filed: Jun. 17, 2004

(30) Foreign Application Priority Data
Jun. 20, 2003 (JP) 2003-176539

(51) Int. Cl. H04N 7/16

(52) U.S. Cl. 725/151; 725/143; 725/153; 725/139

(57) ABSTRACT

1. A multi-media receiving device, comprising a contents input unit that receives contents data input from multiple connected external devices, a contents transmission unit that transmits input contents data to a terminal device, a storing unit that stores multiple application programs corresponding to the types of multiple connected devices, and an application transmission unit that transmits an application program, selected from the multiple application programs, based on the types of multiple connected external devices, to the terminal device. The application transmission unit transmits an application program to the aforementioned terminal device, the program being selected from the multiple application programs based on the type of the recording/playback device that is supplying the contents data to the contents input unit, thereby providing an environment wherein various operations can be performed with portable equipment while the user is viewing and listening to contents.

### BACKGROUND OF THE INVENTION

1. Field of the Invention

The present invention relates to a multi-media receiving device and a multi-media receiving system, and particularly relates to a multi-media receiving device (such as a television receiving device) and a multi-media receiving system wherein digital broadcast programs or moving image contents can be easily viewed and listened to on a portable information terminal.

2. Description of the Related Art

As digital high-definition broadcasting and television receivers for high definition have become common, enjoying impressive pictures with high image quality at home has become easier than ever.

Efforts are being made to enable receiving digital broadcast contents on widely used portable communication devices, such as cellular telephones or portable information terminals (PDAs), so that users can enjoy the digital broadcast contents even while outside the home.

However, in the case of receiving digital broadcast contents, recording the program of one's choice, and viewing and listening at a later time, a recording device is necessary, but it has been difficult to include the recording device and reduce the size to a portable size.

As a method for enjoying the contents recorded by a user on portable equipment, a proposal has been made in Japanese Patent Laid-Open No. 2002-77839 for a system wherein a digital television broadcast is first recorded onto a recording server, then the contents are transferred from the recording server to the portable telephone and the received contents are played back on the portable telephone.

However, conventional technology, including the above-described proposal, does not offer an environment wherein a user can perform various “operations” while viewing and listening to contents on portable equipment.

For example, when a user views and listens to television broadcast contents or pre-recorded program contents, various operations are performed at the television receiving device or the recording device, such as: in the case of television broadcast, channel changing operations; in the case of recorded program contents, operations such as pause, playback, fast forward, and rewind; in the case that the recording device is a hard disk drive (hereafter abbreviated to “HDD”) recording device, operations such as instant replay or delayed playback while recording; in the case of a bilingual broadcast, switching over audio; in the case of a multi-angle program, angle-switching operations; and in the case of viewing contents of a program with an aspect ratio of 16:9 on a television with a screen that has an aspect ratio of 4:3, selection of the screen display method (blank areas on top and bottom of screen/horizontal compression). These operations are normally performed by operating a remote control unit with many buttons for a television or recording device.

However, due to the nature of portable equipment, numerous buttons cannot be provided, and providing new buttons for the purpose of performing various operations while viewing and listening to program contents such as that described above is not realistic. Further, a method might be considered wherein all of the above-described functions are each assigned in advance to one button on the portable equipment, but users would have difficulty in remembering which function was assigned to which button. Further, with an arrangement wherein a guide is displayed on the screen indicating the assigned functions for each button, the user would not have to remember the function for each key, but in the event that all of the operation functions described above are displayed, that by itself would fill the screen, and especially with portable equipment that has a limited screen size, viewing of the contents would be prevented.

### SUMMARY OF THE INVENTION

Accordingly, it is an object of the present invention to solve the above-described problems and provide a multi-media receiving device and system capable of easily performing various operations while viewing and listening to contents, even in the case of viewing and listening to contents on portable equipment.

In a first aspect, the multi-media receiving device according to the present invention comprises: a contents input unit that receives contents data input from multiple connected external devices; a contents transmission unit that transmits input contents data to a terminal device: a storing unit that stores multiple application programs corresponding to the types of multiple connected devices; and an application transmission unit that transmits an application program, selected from the multiple application programs, based on the types of multiple connected external devices, to the terminal device.

In a second aspect, the multi-media receiving device according to the present invention comprises: a recording contents input unit that receives contents data supplied from a recording/playback device; a broadcast contents input unit that receives digital broadcast contents data; a contents transmission unit that transmits input contents data to the terminal device; a storing unit that stores multiple application programs corresponding to each of the recorded contents and broadcast contents; and an application program selected from the multiple application programs, based on whether the contents data is recorded contents or broadcast contents.

In a third aspect, the multi-media receiving device according to the present invention comprises a contents input unit that receives contests data; an attributes obtaining unit that obtains attributes of input contents data; a contents transmission that transmits the input contents data to a display terminal device; a storing unit that stores multiple application programs; an application transmission unit that transmits the multiple application programs to the display terminal device, and an application transmission unit that transmits to the display terminal device; and an application program selected from the multiple application programs, based on contents attributes.

In a fourth aspect, the multi-media receiving system according to the present invention comprises: a multi-media receiving device; a display terminal device that performs data exchange with the multi-media receiving device via a network; and a recording/playback device connected to the multi-media receiving device; the multi-media receiving device comprising: a broadcast contents receiving means unit that receives contents, an accumulated contents input unit that receives contents data from the recording/playback device, a contents transmission unit that transmits broadcast contents or accumulated contents data to the display terminal device, in accordance with instructions from the display terminal device, a storing unit that stores multiple application programs, and an application transmission unit that transmits to the display terminal device an application program selected from the multiple application programs, according to whether the contents being transmitted to the display terminal device are broadcast contents or contents input from the recording/playback device; and the display terminal device comprising: a receiving unit that receives contents data transmitted from the multi-media receiving device, a contents playback unit that plays back the received contents data, a display unit that displays picture data, and an application execution unit that executes an application program that is transmitted from the multi-media receiving device simultaneously with the contents playback.

In a fifth aspect, the multi-media receiving system according to the present invention comprises: a multi-media receiving device; a display terminal device that performs data exchange with the multi-media receiving device via a network; and a recording/playback device that is connected to the multi-media receiving device; the multi-media receiving device comprising: a broadcast contents receiving unit that receives broadcast contents data, an accumulated contents input unit that receives contents data input from the recording/playback device, a contents attributes obtaining unit that obtains the attributes of the input contents data, a contents transmission unit that transmits broadcast contents data or accumulated contents data, corresponding to the instruction from the display terminal device, to the display terminal device, a storing unit that stores multiple application programs, and an application transmission unit that selects one of the multiple application programs, based on the contents attributes obtained by the contents attribute obtaining unit, and transmits the one application program to the display terminal device; and the display terminal device comprising: a receiving unit that receives contents data transmitted from the multi-media receiving device, a contents playback unit that plays back the received contents data, a display unit that displays picture data, and an application execution unit that executes an application program that is transmitted from the multi-media receiving device simultaneously with the contents playback.

In a sixth aspect, the multi-media receiving system according to the present invention comprises: a multi-media receiving device; a recording/playback device connected to the multi-media receiving device; a display terminal device that performs data exchange via a network with the display terminal device and an application program server that performs data exchange via a network with the display terminal device; the multi-media receiving device comprising: a broadcast contents receiving unit that receives digital broadcast contents, an accumulated contents input unit that receives accumulated contents data from the recording/playback device, a contents attributes obtaining unit that obtains attributes of the input contents data, a contents transmission unit that transmits to the display terminal device broadcast contents data or accumulated contents data, corresponding to the instructions from the display terminal device, a storing unit that stores a network address wherein multiple application programs are stored, and an application address transmission unit that selects one of the multiple application programs, based on the contents attributes obtained by the contents attribute obtaining unit, and transmits the network address of the application program corresponding to the display terminal device; and the display terminal device comprising: a receiving unit that receives contents data transmitted from the multi-media receiving device, a contents playback unit that plays back the received contents data, a display unit that displays picture data, and an application execution unit that executes an application program simultaneously with the contents playback, wherein the application program is obtained from the application server, based on the network address of the application program transmitted from the multi-media receiving device.

According to the television receiving device and television receiving system as described above, an environment can be provided wherein the user can easily perform various operations while viewing and listening to contents, even in the case of viewing and listening to contents on a portable information device.

Further objects, features and advantages of the present invention will become apparent from the following description of the preferred embodiments with reference to the attached drawings.

### BRIEF DESCRIPTION OF THE DRAWINGS

FIG. 1 is a diagram illustrating the configuration of a television receiving system according to an embodiment of the present invention;

FIG. 2 is a block diagram illustrating the configuration of a digital television receiver according to an embodiment of the present invention;

FIG. 3 is a diagram illustrating the external view of a portable information terminal according to an embodiment of the present invention;

FIG. 4 is a block diagram illustrating the configuration of a portable information terminal according to an embodiment of the present invention;

FIG. 5 is a flowchart illustrating operations of the portable information terminal, a digital television receiving device, and an HDD recording device according to a first embodiment of the present invention;

FIG. 6 is a diagram illustrating an example display of a program contents list to be displayed on the portable information terminal according to an embodiment of the present invention;

FIG. 7 is a diagram of an information table that shows programs which can be played back, and is managed by the CPU of the digital television receiving device according to the first embodiment of the present invention;

FIG. 8 is a diagram illustrating table information to be used in processing for determining XML data to be transmitted to the portable information terminal by the CPU of the digital television receiving device according to the first embodiment of the present invention;

FIGS. 9A, 9B and 9C are diagrams illustrating display examples of a viewing screen on the portable information terminal according to the first embodiment of the present invention;

FIG. 10 is a diagram illustrating one example of the content of XML data to be transmitted to the portable information terminal according to the first embodiment of the present invention;

FIG. 11 is a flowchart illustrating operations of the portable information terminal, digital television receiving device, and HDD recording device, according to the first embodiment of the present invention;

FIG. 12 is a diagram of an information table that shows the programs that can be played back, and is managed by the CPU of the digital television receiving device according to a second embodiment of the present invention;

FIG. 13 is a flowchart illustrating a processing flow for determining XML data to be transmitted to the portable information terminal by the CPU of the digital television receiving device according to the second embodiment of the present invention;

FIG. 14 is a diagram illustrating table information to be used in processing for determining XML data to be transmitted to the portable information terminal by the CPU of the digital television receiving device according to the second embodiment of the present invention;

FIG. 15 is a diagram of an information table showing programs that can be played back, and is controlled by the CPU of the digital television receiving device according to a third embodiment of the present invention;

FIG. 16 is a flowchart illustrating a processing flow for determining XML data to be transmitted to the portable information terminal by the CPU of the digital television receiving device according to the third embodiment of the present invention;

FIG. 17 is a diagram illustrating table information to be used in processing for determining XML data to be transmitted to the portable information terminal by the CPU of the digital television receiving device according to the third embodiment of the present invention;

FIG. 18 is a flowchart illustrating a processing flow for determining XML data to be transmitted to the portable information terminal by the CPU of the digital television receiving device according to a fourth embodiment of the present invention;

FIGS. 19A and 19B are diagrams illustrating table information to be used in processing for determining XML data to be transmitted to the portable information terminal by the CPU of the digital television receiving device according to the fourth embodiment of the present invention;

FIGS. 20A and 20B are diagrams illustrating an example of the content of XML data to be transmitted to the portable information terminal according to the fourth embodiment of the present invention, and is a diagram illustrating the views before and after rewriting processing;

FIG. 21 is a diagram illustrating a display example of the contents viewing screen of a portable information terminal according to the fourth embodiment of the present invention;

FIGS. 22A and 22B are diagrams illustrating display examples of the contents viewing screen of a portable information terminal according to the second embodiment of the present invention; and

FIGS. 23A and 23B are diagrams illustrating display examples of the contents viewing screen of a portable information terminal according to the third embodiment of the present invention.

### DESCRIPTION OF THE PREFERRED EMBODIMENTS

Now, a multi-media receiving device and multi-media receiving system comprising a television receiving device and television receiving system according to the present invention will be described in detail while referencing the drawings.

First Embodiment

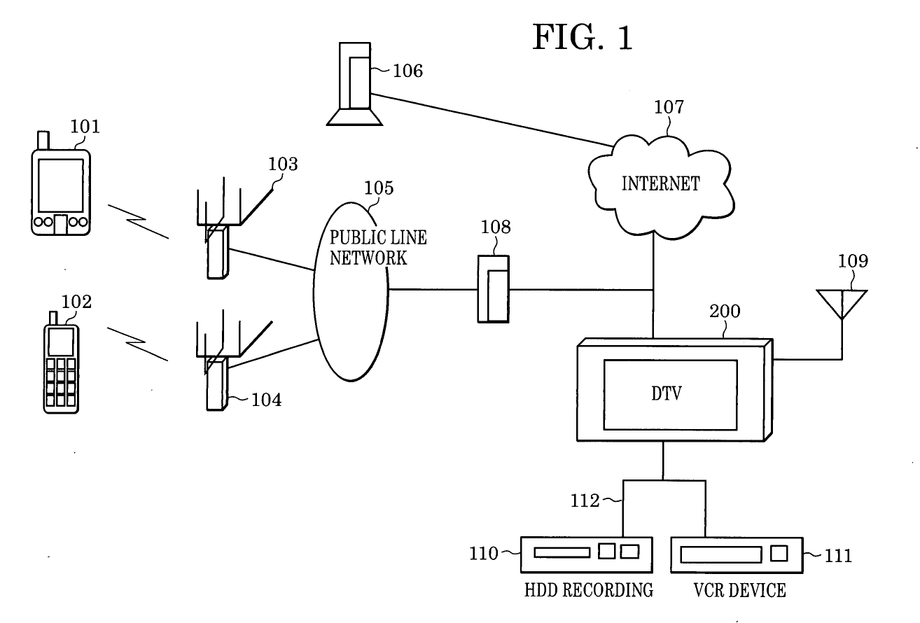

FIG. 1 illustrates an embodiment of a television receiving system according to the present invention. Base stations 103 and 104 are stationary wireless base stations installed within regions called cells, which are divisions of appropriate size of the communication service providing area. Base stations 103 and 104 are wirelessly connected to portable information terminals 101 and 102 which are mobile wireless stations, and large amounts of data can be communicated there between at a high speed.

The base stations 103 and 104 are connected to a public network line 105 via a cable network, and the public network line 105 is connected to the Internet 107 via an Internet access server 108. The Internet 107 is connected to a WWW server 106 and a digital television receiving device 200. The digital television receiving device 200 is connected to an antenna 109 for receiving broadcasts, and to a VCR device 111 as an example of a digital VTR device, or an HDD recording device 110 (external device(s)), via a home network 112 (e.g., an IEEE 1394 serial bus).

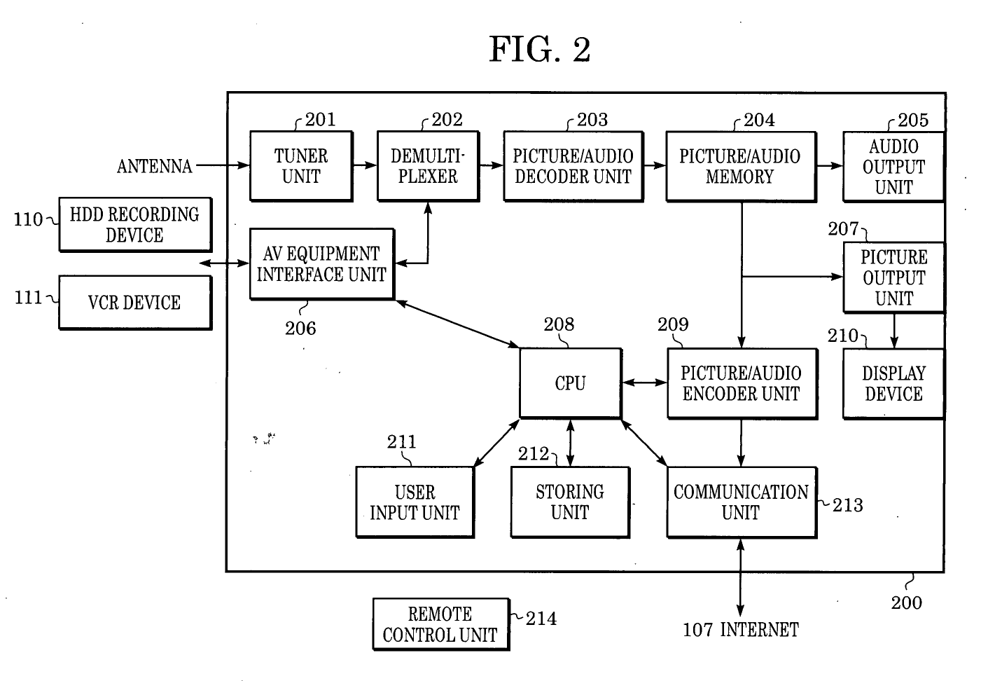

FIG. 2 is a diagram illustrating the configuration of a digital television receiving device 200. Here, a signal received from the antenna 109 is input to the tuner unit 201. The tuner unit 201 performs processing such as demodulation, error correction, and so forth, according to the input signal, and generates digital data in a form called a transport stream. The tuner unit 201 further performs descrambling processing on the generated transport stream (TS) data, and outputs to a demultiplexer unit 202.

The demultiplexer unit 202 extracts the picture data and the audio data from the TS data containing time-division-multiplexed picture data, audio data, program information data, and broadcast data, of multiple channels input from the tuner unit 201, and outputs extracted picture data and audio data to a picture/audio decoder unit 203. The picture data and audio data processed in the picture/audio decoder unit 203 is written to picture/audio memory 204, and the picture information is output to a display device 210 via a picture output unit 207. Similarly, audio data is output to an audio output unit 205.

An AV (audio-visual) equipment interface unit 206, (content input means), performs transmission and receiving of picture data, audio data, and control commands between the VCR device 111 and the HDD recording device 110, connected externally by the IEEE 1394 serial bus. In the case of outputting picture/audio signal to the VCR device 111 or the HDD recording device 110, the demultiplexer 202 partially processes the above-described TS data, and outputs this as TS data for accumulation to the AV equipment interface unit 206. Next, this data is converted to IEEE 1394 stipulated isochronous transmission data at the AV equipment interface unit 206, and is output to the VCR device 111 or HDD recording device 110.

In the reverse situation, in which the VCR device 111 or the HDD recording device 110 performs playback operation, and isochronous transmission data is input into the AV equipment interface unit 206 via the IEEE 1394 serial bus, this data is converted to TS data for accumulation at the AV equipment interface unit 206, and further supplied to the picture/audio decoder unit 203 as picture data or audio data, by the demultiplexer unit 202.

The picture/audio encoder unit 209 compression encodes the content of picture/audio memory, based on the specified encoding method for MPEG (Moving Picture Experts Group) 2 or MPEG4, and by doing so, converts the content to encoded image data, and sends this data to a communication unit 213. The communication unit 213 transmits the information from the picture/audio encoder unit 209 to the portable information terminal (101 or 102) through an Internet line 107, and further performs command notification between the portable information terminals 101 and 102.

Note that the picture/audio encoder unit 209 according to the present embodiment transmits all pictures to the portable information terminals at an aspect ratio of 4:3, regardless of the contents video format (for example, 16:9 or 4:3).

The CPU (central processing unit) 208 is responsive to communication from a user input unit 211 or a remote control unit 214, and performs control and settings to each of the above-mentioned units, according to programs stored in a recording unit 212 (recording means), and controls operations of the digital television receiving device according to the present embodiment. The recording unit 212 also stores necessary information according to the requests from the CPU 208. The recording unit 212 further stores multiple application programs to be transmitted from the communication unit 213 (application transmission means), e.g., to the later-described portable information terminal 102.

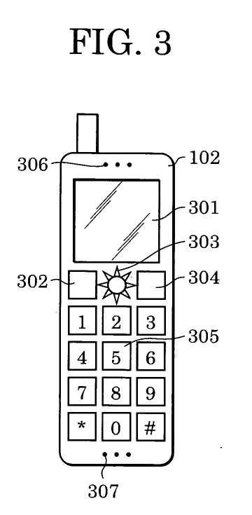

FIG. 3 is a diagram illustrating in greater detail a portable information terminal 102 (mobile terminal device) of the present invention. The portable information terminal 102, also called a cellular telephone, has a liquid crystal display 301 on the front, and displays registered names, airwave status, talk time, and battery status, and reproduces email contents, WWW contents, still images, and moving image contents. The portable information terminal 102 further includes a call key 302, an on-hook/power key 304, and numeral keys 305 (“0” to “9”) provided under the display, a “cursor and decision” key 303 which combines a directional key for up/down/right/left and a decision key by means of depressing, a speaker 306 and a microphone.

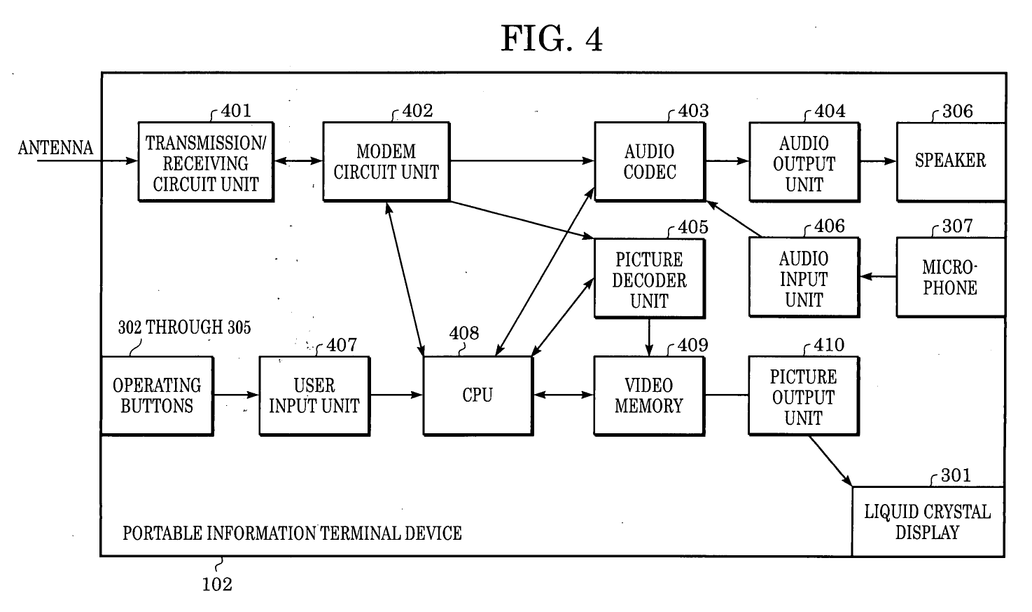

FIG. 4 is a block diagram illustrating the configuration of the portable information terminal 102. The data received from the base station via the antenna 109 is demodulated at a transmission/receiving circuit unit 401 and a modem circuit unit 402. Audio data is input to an audio codec unit 403, and output from a speaker 306 via an audio output unit 404. Picture data is input to a picture decoder unit 405, and after being temporarily stored in video memory 409, is output to the liquid crystal display 301 via a picture output unit 410. Further, text data or program data is first supplied to the CPU 408, and, based on the software running on the CPU, specified decoding processing is performed or the program is executed, and the operation results are written to the video memory 409 as display data, and output to the liquid crystal display 301 along with the above-described picture signal. Note that in the present embodiment, XML (extendable Markup Language) which describes an application program, and a browser application for executing script, are executed by the CPU 408. The microphone 307, audio input unit 406 and audio codec 403 provide means for user audio input. Operating buttons 302 to 305 provide manual input via a user input unit 407 to the CPU 408.

(Description of Processing Operations)

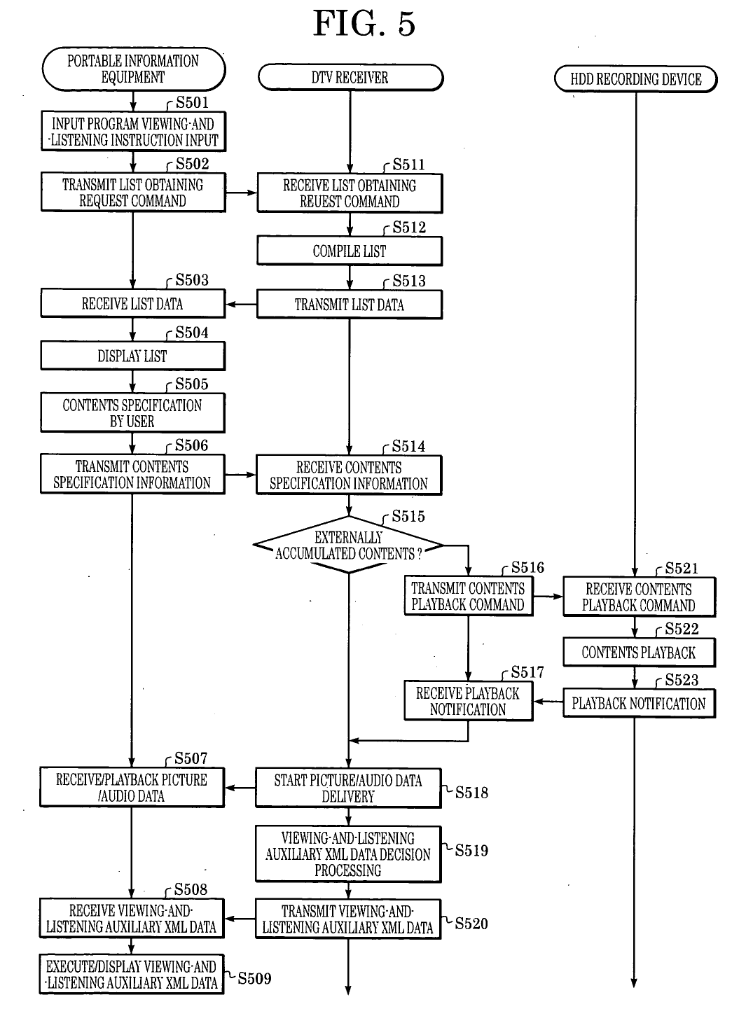

Next, operation of the television receiving system according to the present embodiment will be described. FIG. 5 is a diagram illustrating the operation flow of CPU 208 of the digital television receiving device 200, the CPU 408 of the portable information terminal 102, and the HDD recording device 110, and the relationship thereof. Note that the present embodiment will be described under the assumption that the HDD recording device 110 and VCR device 111 have previously accumulated multiple program contents.

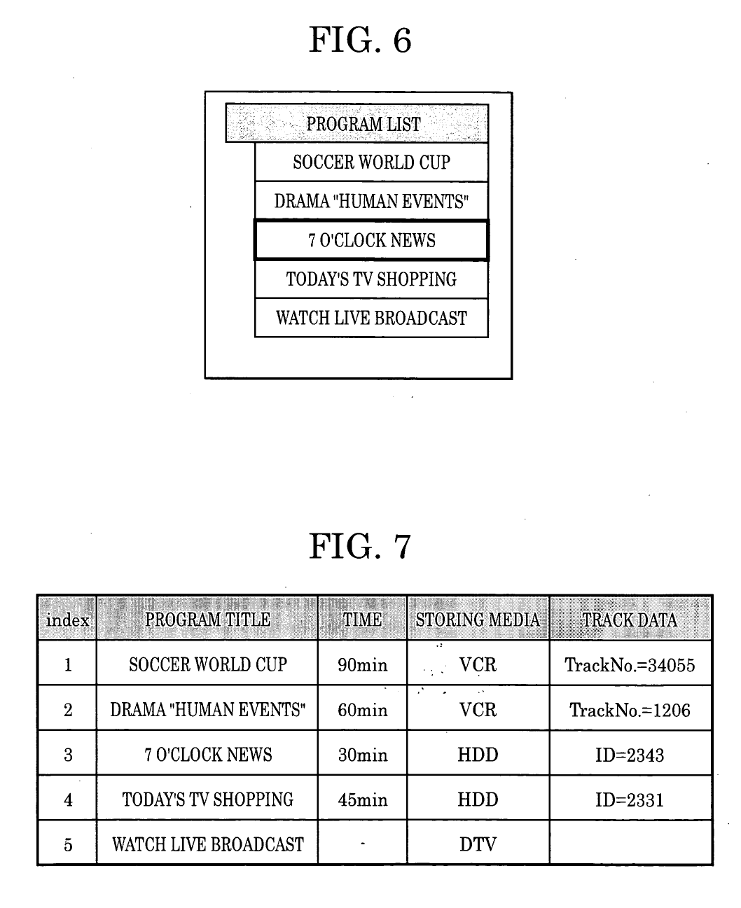

First, upon the user instructing the portable information terminal 102 to view and listen to television (S501), the CPU 408 of the portable information terminal 102 transmits a contents list request command (S502) to the digital television receiving device 200. Upon the CPU 208 of the digital television receiving device receiving a command-reception notification from the communication unit 213 (S511), a list of previously recorded contents available for current viewing and listening is generated (S512), and transmitted to the portable information terminal (S513) via the communication unit 213. The CPU 408 of the portable information terminal supplies the received list information to the browser application, and at the same time the browser application converts the list information to text or graphic information, and renders this at the video memory 409 (S503 through S504). FIG. 6 is a diagram illustrating a display example of the liquid crystal display 301 at this time.

With a display as shown in FIG. 6 being displayed on the portable information terminal 102, in the event that the user operates the above-described “cursor and decision” key to move the cursor within the list and select one of the program contents (S505), contents specification information is notified as a command (S506) from the CPU 408 of the portable information terminal 102 to the digital television receiving device 200. Upon the CPU 208 of the digital television receiving device receiving the notification (S514) with the contents specification information, the media storing the specified contents is searched according to the contents list information illustrated in FIG. 7.

The contents list information illustrated in FIG. 7 is a list showing information of contents previously accumulated (pre-recorded) and available for current viewing and listening with the digital television receiving device 200, and the program title, playback time, type information of the accumulating device (accumulating media) of each of the contents, and the information necessary to perform track playback, is listed. For example, the contents of Index Number 1 in FIG. 7 are stored in a VCR device 111, and in order to play back the contents of this program, instructions can be given to the VCR device 111 to the effect that the tape needs to be wound to track number 34055 and play for 90 minutes. Further, the contents of Index Number 3 are accumulated in an HDD recording device 110, and in order to play these back, the ID 2343 needs to be transmitted to the HDD recording device 110.

The CPU 208 of the digital television receiving device 200 performs a command transmission (S515) via the AV equipment interface 206 to an external device, in the case that the contents specified by the portable information terminal 101, 102 is contents recorded to an external device, namely the HDD recording device 110 or the VCR device 111. For example, in the case of the contents illustrated in Index 3 of FIG. 7, the playback request for recording contents called ID=2343 is transmitted via the AV equipment interface to the HDD recording device 110 (S516). After receiving the contents playback command from the digital television receiving device 200 (S521), the HDD recording device the begins playback of these contents (S522). The HDD recording device 110 sends a playback notification command to the digital television receiving device 200 when complete (S523).

Upon the CPU 208 of the digital television receiving device 200 receiving a playback notification from the HDD recording device (S517), the CPU 208 controls the AV equipment interface 206 and the demultiplexer unit 202, receives the isochronous transmission data from the HDD recording device 110, supplies this data to the picture/audio decoder unit 203, and outputs the resulting processed data to the picture/audio memory 204. Further, the CPU 208 of the digital television receiving device 200 controls the picture/audio encoder unit 209, processes the content of the picture/audio memory 204 by MPEG compression encoding, and transmits it to the portable information terminal 102 via the communication unit 213.

Similarly, in the case that the user of the portable information terminal specifies the contents illustrated in Index 1 of FIG. 7, a playback command for contents is transmitted from the digital television receiving device 200 to the VCR device 111. The processing after this is the same as in the case of the HDD recording device 110.

Further, in the case that the user specifies the “WATCH LIVE BROADCAST” illustrated in Index 5 of FIG. 7, the CPU 208 of the digital television receiving device 200 controls the tuner unit 201 and begins receiving the program currently being broadcast, and at the same time, the DATA stream is supplied from the tuner unit 201 to the demultiplexer 202 and the picture/audio decoder HNIT 203, and is output to the picture/audio memory 204.

Further, the CPU 208 of the digital television receiving device 200 controls the picture/audio encoder unit 209 and the communication unit 213, performs MPEG compression encoding of the content of the picture/audio memory 204, and transmits this to the portable information terminal 102 (S518).

Upon the CPU 408 of the portable information terminal 102 receiving the MPEG data transmitted from the digital television receiving device 200, the CPU 408 supplies this to the audio codec 403 and the picture decoder 405, and begins playback of the contents (S507).

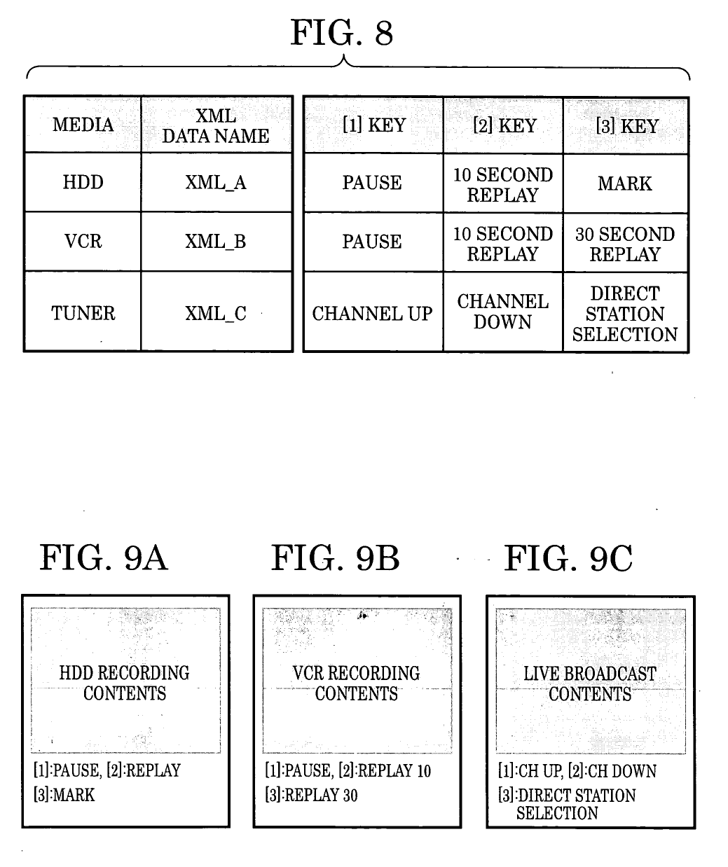

Next, the CPU 208 of the digital television receiving device 200 performs selection processing of auxiliary (or aid) XML data for viewing and listening (S519). This processing is for selecting XML data determined in advance based on the source of contents and the type of accumulating device (accumulating media) of the contents, and in the present embodiment uses the table illustrated in FIG. 8. For example, in the event that the recorded contents of the HDD recording device 110 is transmitted to the portable information terminal 102, XML data called XML_A is selected; in the event that the recorded contents of the VCR device 111 is transmitted to the portable information terminal 102, XML data called XML_B is selected; and further, in the event that a live program, which is broadcast contents input via the tuner unit 201, is transmitted to the portable information terminal 102, XML_C is selected (S520).

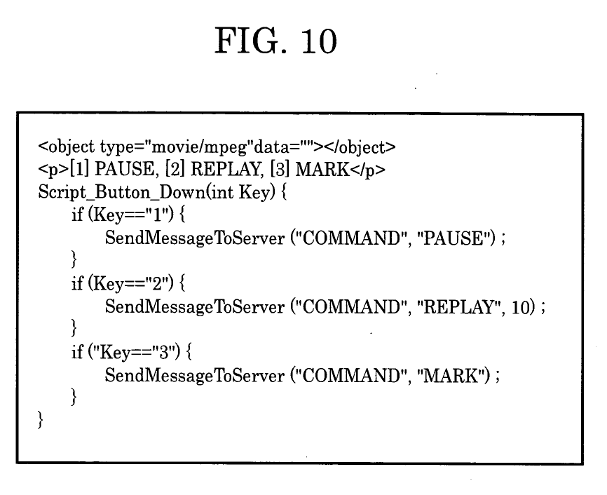

FIG. 10 is a diagram illustrating the content of XML_A, and this XML data includes the layout information for the purpose of displaying moving contents, and underneath has character examples for the purpose of showing users the function guide assigned to each key [1], [2], and [3]. Further, underneath each a script is shown to illustrate the operation for when each of the keys [1], [2], [3] is depressed on the portable information terminal 102. Here an example is shown wherein the “viewing and listening contents operation command” transmitted from the portable information terminal 102 to the digital television receiving device 200 is differentiated for each key [1], [2], and [3].

FIG. 8 also illustrates the function that each XML data set has, and a function guide and a script is described for each XML data set corresponding to each function illustrated in the same diagram.

Upon the CPU 408 of the portable information terminal receiving the XML data (S508), the CPU 408 supplies this data to the browser application, and, at the same time, performs layout processing and text/graphic information rendering according to the XML data (S509). FIGS. 9A, 9B, and 9C are diagrams illustrating the XML data displayed on the liquid crystal display of the portable information terminal 102, wherein FIG. 9A is an example in the case of XML_A of FIG. 8, FIG. 9B is an example in the case of XML_B of FIG. 8, and FIG. 9C is an example in the case of XML_C of FIG. 8. The rectangular region of the upper portion of the diagram is the area in which the moving image picture is displayed, and the region displaying text characters at the bottom portion is the operation guide.

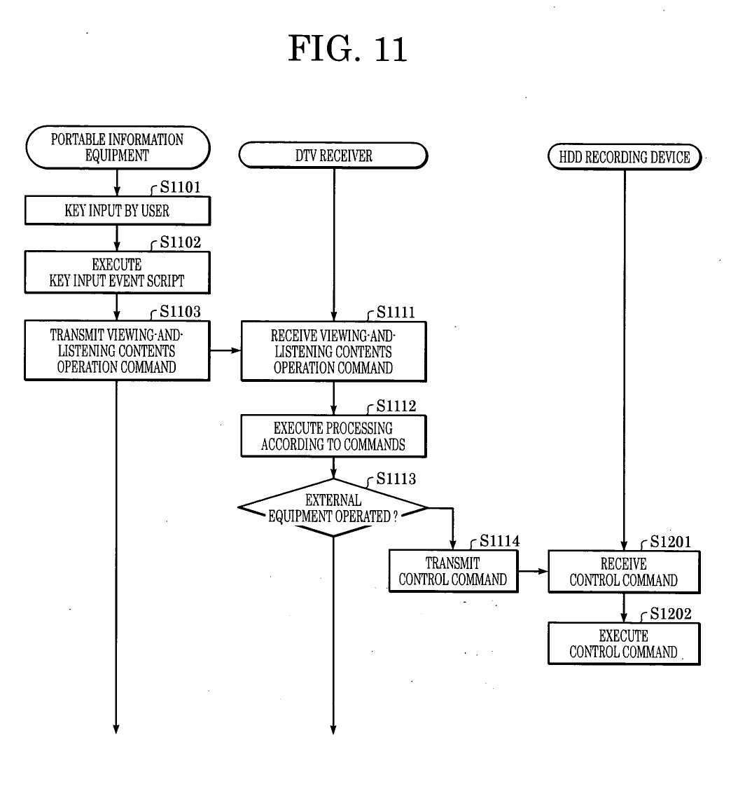

Next, operations in the case that the user operates a button on the portable telephone 102 while watching or listening to contents will be described, with reference to FIG. 11. After completing the processing in FIG. 5, i.e., while the display of the liquid crystal display 301 of the portable information terminal 102 is as illustrated in FIGS. 9A, 9B, and 9C, upon the user pressing one of the buttons [1], [2], or [3] (S1101), the browser application that runs on the CPU 408 of the portable information terminal 102 performs processing according to the script described in the XML data (S1102).

For example, in the case of XML_A illustrated in FIG. 10, upon the [1] key being depressed, a “viewing and listening contents operation command message” is transmitted to the DTV 200 with the data “PAUSE”. Further, upon the [2] key being depressed, the “viewing and listening contents operation command message” is transmitted with the data “REPLAY” and the data “10”, and upon the [3] key being depressed, the “viewing and listening contents operation command message” is transmitted with the data “MARK” (S1103).

In the event that the CPU 208 of the digital television receiving device 200 receives a “viewing and listening contents operation command message” from the portable information terminal (S1111), the CPU 208 performs processing according to that command (S1112). In the case that this processing requires an operation regarding an external device (S1113), the AV control command for the IEEE 1394 serial bus is transmitted via the AV equipment interface unit 206 (S1114). For example, in the event that a “viewing and listening contents operation command” with the data “PAUSE” is received during transmission of the contents accumulated in the HDD recording device 110 to the portable information terminal 102, a pause request command is transmitted to the HDD recording device 110. Further, in the event that a “viewing and listening contents operation command” with the data “REPLAY” and “10” is received (S1201), a command is transmitted to the HDD recording device to rewind the currently-playing contents by 10 seconds (S1202). Further, in the event that a “viewing and listening contents operation command” with the data “MARK” is received (S1201), a marking command is transmitted to the HDD recording device (S1202). According to the present embodiment, upon the HDD recording device 110 receiving a marking command (S1201), the elapsed time of the contents being played is recorded, and when the user instructs the HDD recording device 110 at a later time, the marked contents can automatically be played back (S1202).

The results of the above-described operations will now be summarized. In the event a list such as that illustrated in FIG. 6 is displayed on the portable information terminal 102 by the processing of S501 to S504 and S511 to S513 in FIG. 5, if the user has specified the contents “7 O'CLOCK NEWS”, the playback begins for the contents with the ID number specified in the HDD recording device 110, by means of the processing of S505 to S507, the processing of S514 to S518 in FIG. 5, and the table data illustrated in FIG. 7, and that picture/audio data is transmitted to the portable information terminal 102 via the digital television receiving device 200. The XML data called XML_A is then selected. By the processing of S508 to S509 and S519 to S520 in FIG. 5 the XML data called XML_A is selected according to the data illustrated in FIG. 8, and is transmitted to the portable information terminal 102, where a display similar to that in FIG. 9A is displayed on the liquid crystal display 301.

Now, in the event that the user presses the [1] key while viewing or listening to contents, a viewing and listening contents operation command is transmitted to the digital television receiving device 200 by means of the processing of S1101 to S1103, the processing of S1111 to S1114, and the processing of S1201 to S1202, and, in accordance with that command, a pause request is sent from the digital television receiving device 200 to the HDD recording device 110. Further, in the event that the [2] key is pressed, a command to rewind the playback contents for 10 seconds is sent to the HDD recording device 110, and further, when the [3] key is pressed, a marking command is sent to the HDD recording device 110.

In the event that the user specifies “WATCH LIVE PROGRAM” while the list display illustrated in FIG. 6 is displayed on the portable information terminal by means of processing of S501 to S504 and S511 to S513 of FIG. 5, a picture/audio stream is input via the tuner unit 201 of the digital television receiving device 200 by means of the processing of S505 to S507 and the processing of S514 to S518 of FIG. 5 according to the data illustrated in FIG. 7, and this picture/audio data is transmitted via the digital television receiving device 200 to the portable information terminal. Next, the XML data called XML_C is selected by means of the processing of S508 to S509 and the processing of S519 to S520 of FIG. 5 and the data illustrated in FIG. 8, and sent to the portable information terminal 102, and a display similar to FIG. 9C is displayed on the liquid crystal display 301. Then, in the event that the user presses the [1] key while viewing or listening to contents, a “viewing and listening contents operation command” is transmitted to the digital television receiving device by means of the processing of S1101 to S1103 and the processing of S1111 to S1113, and, in accordance with that command, a station selection change instruction is sent to the tuner unit 201 of the digital television receiving device 200. This is also the same in the case of pressing the [2] key.

Further, in the event that the user specifies the contents “SOCCER WORLD CUP” while the list display illustrated in FIG. 6 is displayed on the portable information terminal 102 by means of processing of S501 to S504 and S511 to S513 of FIG. 5, playback from the specified track number of the VCR device 111 is started by means of the processing of S505 to S507 and the processing of S514 to S518 of FIG. 5 and the data illustrated in FIG. 7, and this picture/audio data is transmitted via the digital television receiving device 200 to the portable information terminal 102. Next, the XML data called XML_B is selected by means of the processing of S508 to S509 and the processing of S519 to S520 of FIG. 5 and the data illustrated in FIG. 8, and is sent to the portable information terminal 102, and a display similar to that in FIG. 9B is displayed on the liquid crystal display 301. Then, in the event that the user presses the [1] key while viewing or listening to contents, a “viewing and listening contents operation command” is transmitted to the digital television receiving device 200 by means of the processing of S1101 to S1103, the processing of S1111 to S1113, and the processing of S1201 to S1202, and, in accordance with that command, a pause instruction is sent to the VCR device 111. Further, in the event that the [2] key is pressed, a command is sent to the VCR device 111 to rewind for 10 seconds and replay, and in the event that the [3] key is pressed, a command is sent to the VCR device 111 to rewind for 30 seconds and replay.

As described above, according to the first embodiment of the present invention, XML data for viewing and listening aid is sent with the contents to a portable information terminal 102, and in the event that a user presses one of the keys [1], [2], or [3] while viewing or listening, the desired operations can be performed on the function units within the digital television receiving device 200 or the device playing the contents.

Further, since the XML data for viewing and listening aid, making up the multiple application programs, is selected and sent based on the type of the source of the contents or the types of external devices storing the contents, the viewing and listening aid appropriate for the functions of the device playing back the contents can be performed.

For example, the operation called channel up/channel down is meaningful only when viewing or listening to contents via a tuner unit 201, so the channel up/channel down operation guide is displayed and functions only when viewing or listening to contents input by a tuner unit 201.

Further, for example, in the case that an HDD recording device 110 has the above-described marking function, but the VCR device 111 does not have a marking function, the user can use the function without confusion by the function “MARKING” being displayed only during contents playback from the HDD recording device 110 according to the present embodiment.

Further, in the case of displaying the operations guide while playing back contents on a liquid crystal display of small size, there is insufficient space to display text and graphics, as illustrated in FIGS. 9A, 9B and 9C, and therefore a large number of guides cannot be displayed. Even in this situation, selecting the XML data having the script and guide display most suited to the accumulating device for the contents enables operations to be sufficiently performed for the subject contents, even with a guide display showing a limited number of functions.

Second Embodiment

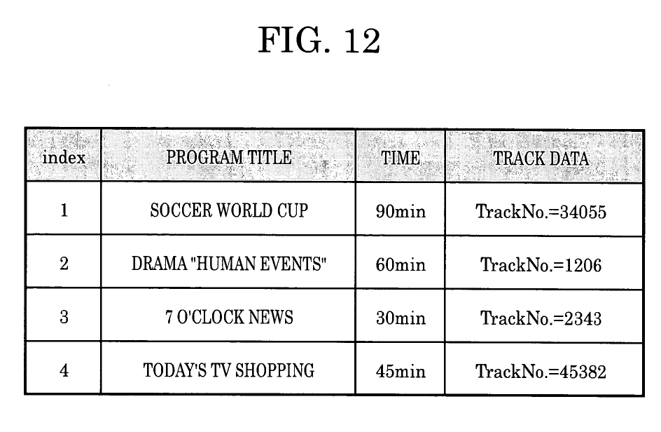

The television receiving system, the digital television receiving device therein, and the external diagram and construction of the portable information terminal, are the same as those in the first embodiment: accordingly, description thereof will be omitted here. Further, the present embodiment will be described under the assumption that multiple program contents such as that illustrated in FIG. 12 have been previously accumulated only in the HDD recording device 110. The operations of the television receiving system of the present embodiment are basically executed with a operational flow similar to that in the first embodiment, as illustrated in FIG. 5.

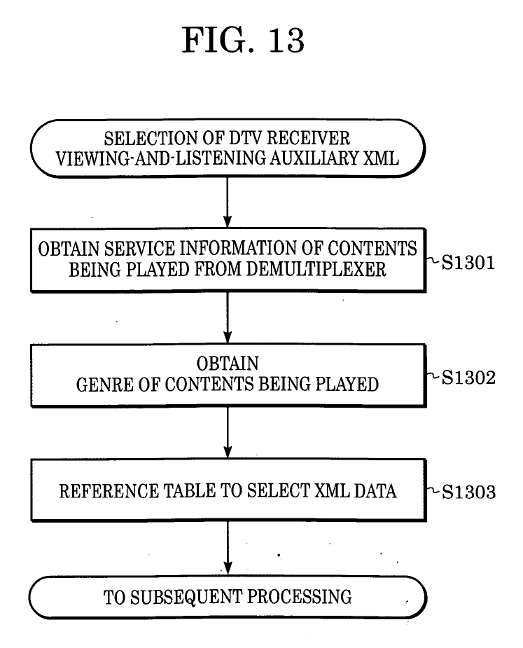

FIG. 13 is a flowchart illustrating in further detail processing wherein the CPU 208 of the digital television receiving device 200 selects XML data for viewing and listening aid (S519 in FIG. 5), according to the present embodiment.

The CPU 208 of the digital television receiving device 200 makes a request to the demultiplexer unit 202 to obtain service information (S1301) of the program contents being transmitted to the portable information terminal 102 during data transmission to the portable information terminal 102, wherein the data transmitted is from an external device, here an HDD recording device 110, via the IEEE 1394 serial bus. Once the service information is obtained, the program genre information therein is read out (S1302).

The service information is data including information of program titles or genre of the service (channel) being broadcast currently (or in the future), or broadcast video formats and so forth, from the broadcast station side multiplexed on program contents data and transmitted. “Genre information” as used here means, for example, categorization of programs such as movies, drama, sports, variety shows, news, shopping, and the like.

The HDD recording device 110 according to the present embodiment records in the form of a data stream with the above-mentioned service information multiplexed thereon when processing the recording of the program contents, and at the time of playback, the multiplexed data stream is supplied along with the program contents to the digital television receiving device 200. The demultiplexer unit 202 extracts the service information from the multiplexed signal, and supplies it to the CPU 208.

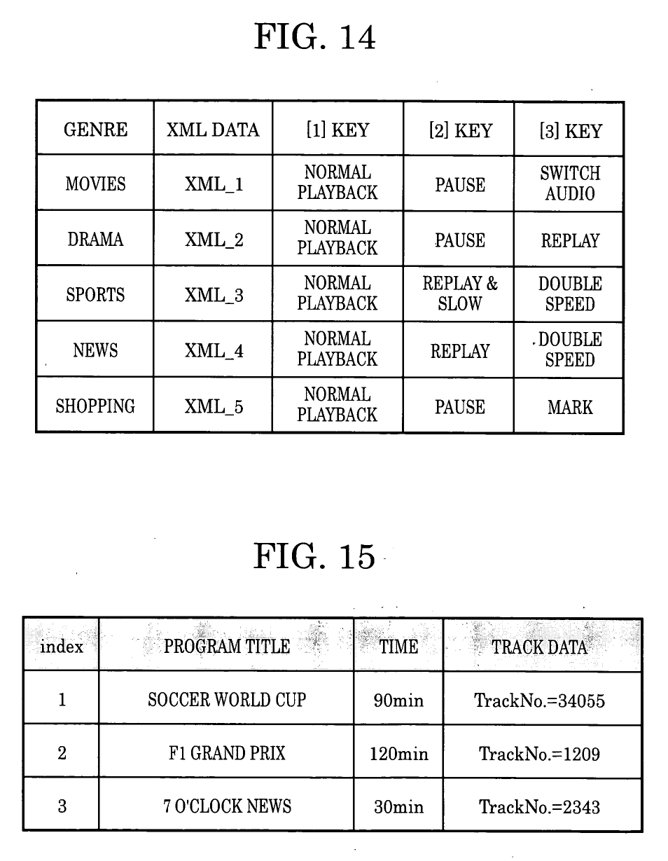

The CPU 208, which has obtained the service information, selects the XML data corresponding to the program genre, according to the table illustrated in FIG. 14 (S1303). For example, in a case wherein the genre of the contents being currently transmitted to the portable information terminal 102 is movie contents, the XML data called XML_1, which has the functions of playback start for the [1] key, pause for the [2] key, and main/sub audio switching for the [3] key, is selected.

Further, in the case that the genre of the contents being currently transmitted to the portable information terminal 102 is drama, the XML data called XML_2, which has the functions of playback start for the [1] key, pause for the [2] key, and replay for the [3] key, is selected.

Further, in the case that the genre of the contents being currently transmitted to the portable information terminal 102 is sports, the XML data called XML_3, which has the functions of playback start for the [1] key, replay and slow playback for the [2] key, and double speed playback for the [3] key, is selected.

Further, in the case that the genre of the contents being currently transmitted to the portable information terminal 102 is news, the XML data called XML_4, which has the functions of playback start for the [1] key, replay for the [2] key, and double speed playback for the [3] key, is selected.

Further, in the case that the genre of the contents being currently transmitted to the portable information terminal 102 is shopping, the XML data called XML_5, which has the functions of playback start for the [1] key, pause for the [2] key, and marking for the [3] key, is selected.

The content description for each of XML_1 to XML_5 are not illustrated in the drawings; however, as with the previous embodiment illustrated in FIG. 10, the script processing corresponding to the button key events and layout information for the purpose of playing back the program contents is described. Also, upon the user depressing the key [1], [2], or [3] while viewing and listening to the contents, this information is transmitted to the digital television receiving device as a “viewing and listening contents operation command”, in accordance with the processing illustrated in FIG. 11, and then is transferred to the HDD recording device 110, and processing is performed.

The following is a description of the operation results of the processing as described above. In the event that a list such as that illustrated in FIG. 6 is displayed on the portable information terminal by means of the processing of S501 to S504 and S511 to S513 in FIG. 5, upon the user specifying the contents “SOCCER WORLD CUP”, the playback begins for the contents with the ID number specified on the HDD recording device 110, by means of the processing of S505 to S507, the processing of S514 to S518 in FIG. 5, and the data illustrated in FIG. 12, and the picture/audio data is transmitted to the portable information terminal 102 via the digital television receiving device.

Next, the genre “SPORTS” of the contents being transmitted to the portable information terminal 102 is obtained by means of the processing of S508 to S509, the processing of S519 to S520, and the processing of S1301 to 1303 of FIG. 13, and in accordance with the table data illustrated in FIG. 14, the data XML_3 is selected as the XML data corresponding to “genre=SPORTS”, and is sent to the portable information terminal. The received XML data is displayed on the portable information terminal 102 as shown in FIG. 22A.

Next, upon the user pressing the [3] key while viewing and listening to contents, a “viewing and listening contents operation command” is transmitted to the digital television receiving device 200 by means of the processing of S1101 to S1103, the processing of S1111 to S1114, and the processing of S1201 to S1202 in FIG. 11, and in accordance with that command, a double-speed playback request is sent to the HDD recording device 110 from the digital television receiving device 200. Further, upon the [2] key being pressed, a request command is sent to the HDD recording device 110 to rewind the contents being played back for 10 seconds, and to play back those 10 seconds at a slow speed.

Further, in the event that the user specifies the contents called DRAMA “HUMAN EVENTS” while the display list illustrated in FIG. 6 is displayed on the portable information terminal according to the processing of S501 to S504 and S511 to S513 of FIG. 5, the playback begins for the contents with the ID number specified on the HDD recording device 110, by means of the processing of S505 to S507, the processing of S514 to S518 in FIG. 5, and the data illustrated in FIG. 12, and the picture/audio data is transmitted to the portable information terminal 102 via the digital television receiving device 200.

Next, the genre “DRAMA” of the contents being transmitted to the portable information terminal is obtained by means of the processing of S508 to S509, the processing of S519 to S520, and the processing of S1301 to 1303 of FIG. 13, and in accordance with the table data illustrated in FIG. 14, the data XML_2 is selected as the XML data corresponding to “genre =DRAMA”, and is sent to the portable information terminal 102. The received XML data is displayed on the portable information terminal 102 shown as in FIG. 22B. In the event that the user presses the [3] key while viewing and listening to contents, a “viewing and listening contents operation command” is transmitted to the digital television receiving device by means of the processing of S1101 to S1103, the processing of S1111 to S1114, and the processing of S1201 to S1202 of FIG. 11, and, in accordance with to that command, a replay request is sent to the HDD recording device 110 from the digital television receiving device 200. Further, in the event that the [2] key is pressed, a request command is sent to the HDD recording device 110 to pause the contents being played back.

As described above, according to the second embodiment of the present invention, XML data for viewing and listening aid is sent with the contents to a portable information terminal 102, and in the event that a user presses one of the keys [1], [2], or [3] while viewing or listening, the desired operations can be performed with regard to those contents. Further, the XML data for the viewing and listening aid to be transmitted is selected according to the genre of contents, and is transmitted; therefore, only the functions applicable to viewing and listening to the contents of that genre is displayed to the user as a viewing and listening aid, and the operations easily can be selected and performed.

For example, in the case of viewing and listening to sports, scoring scenes and so forth are often replayed in slow motion, but replaying in slow motion rarely happens while watching and listening to a drama. Further, while viewing and listening to movies, the audio may be switched to the original language to hear the actor's or actress's voice, for example, but switching audio on news or shopping programs rarely happens.

Thus, operations to be performed during viewing and listening differ according to the genre of the contents the user is viewing and listening to, so, according to the present embodiment, operations during viewing and listening can be easily performed even with limited buttons, by selecting XML data for providing viewing and listening aid to match the genre of contents to be viewed and listened to.

Further, in the case of displaying the operations guide while playing back contents on a liquid crystal display of small size, there is insufficient space to display text and graphics, and therefore a large number of guides cannot be displayed. Even in this situation, selecting the XML data having the script and guide display most suited to the genre of the contents enables operations on the contents to be sufficiently performed, even with a guide display showing a limited number of functions, as illustrated in FIGS. 9A, 9B and 9C.

Third Embodiment

The television receiving system, the digital television receiving device therein, and the external diagram and construction of the portable information terminal are the same as the first embodiment; therefore, the description thereof will be omitted here. Further, the present embodiment will be described under the assumption that the multiple program contents such as that illustrated in FIG. 15 are previously accumulated in the HDD recording device 110. Moreover, of the programs in FIG. 15, let us say that “SOCCER WORLD CUP” is a program broadcast with an aspect ratio of 16:9, and “F1 GRAND PRIX” is a program with an aspect ratio of 4:3 but also is a multi-angle program wherein a viewer is capable of selecting multiple angle images.

Operations of the television receiving system of the present embodiment are executed with an operational flow basically similar to that in the first embodiment, as illustrated in FIG. 5.

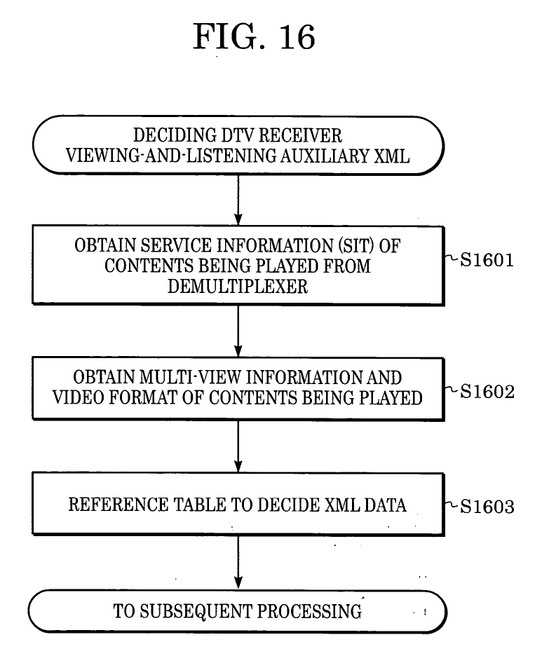

FIG. 16 is a flowchart illustrating in further detail processing wherein the CPU 208 of the digital television receiving device 200 selects XML data for viewing and listening aid (S519 in FIG. 5), according to the present embodiment. The CPU 208 of the digital television receiving device 200 makes a request to the demultiplexer unit 202 to obtain service information (S1601) of the program contents being transmitted to the portable information terminal 102 during data transmission to the portable information terminal 102, wherein the data transmitted is from an external device, here an HDD recording device 110, via the IEEE 1394 serial bus. Once the service information is obtained, the video format information and component group information therein is extracted (S1602).

The service information is data including information of program titles or genre, or broadcast video formats and the like, which is multiplexed at the broadcast station side with program contents data and then transmitted, wherein video format information includes information as to whether the aspect ratio of the program image is 4:3 or 16:9, and also includes information as to whether or not the component group information is in a form called multi-view. Multi-view is a program with a broadcast form wherein, for example, in a live program of auto racing, the user can select from and switch between multiple angles, such as an angle that continuously shows the leading car, an angle that shows only the front of the pit, an angle that shows only the car of a Japanese driver, and the like.

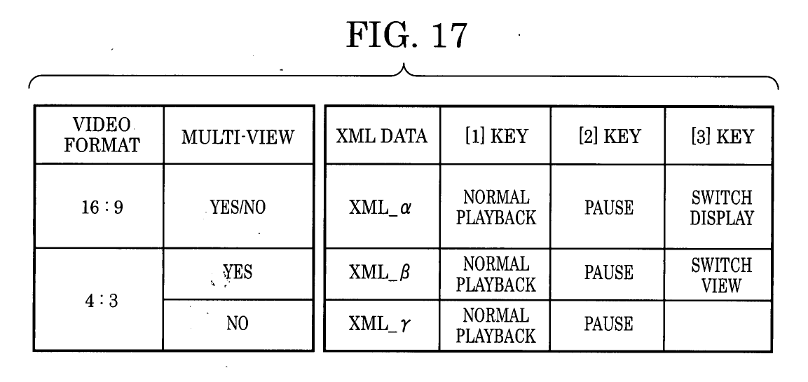

The HDD recording device 110 according to the present embodiment records in the form of a data stream multiplexing the above-mentioned service information when processing the recording of the program contents, and at the time of playback, the multiplexed data stream is supplied along with the program contents to the digital television receiving device 200. The demultiplexer unit 202 extracts the service information from the multiplexed signal, and supplies it to the CPU 208. The CPU 208, which has obtained the service information, selects the XML data corresponding to the combination of video format of the program or the information as to whether or not the program is in multi-view, according to the table shown in FIG. 17 (S1603).

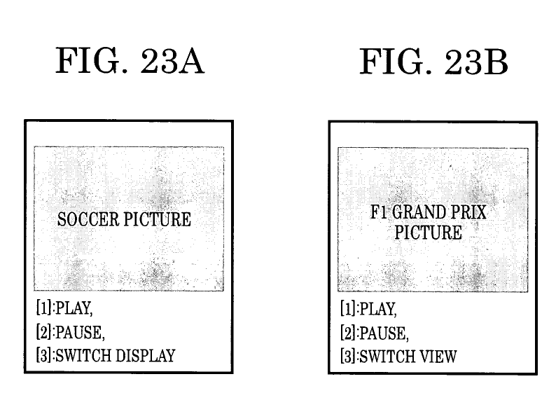

The following is a description of operation results of processing. In the event that the user has specified the contents “SOCCER WORLD CUP” by means of the processing of S501 to S504 and S511 to S513 in FIG. 5, playback begins for the contents with the ID number specified on the HDD recording device 110, by means of the processing of S505 to S507, the processing of S514 to S518 in FIG. 5, and the data illustrated in FIG. 15, and that picture/audio data is transmitted to the portable information terminal 102 via the digital television receiving device 200. Next, the video format “16:9” of the contents being transmitted to the portable information terminal is obtained by means of the processing of S508 to S509, the processing of S519, and the processing of S1601 to 1603 of FIG. 16, and in accordance with the table data illustrated in FIG. 17, data called XML_α is selected as the XML data corresponding to “16:9”, and is sent to the portable information terminal 102. The received XML data is displayed on the portable information terminal as shown in FIG. 23A. Next, in the event that the user presses the [3] key while viewing and listening to contents, a “viewing and listening contents operation command” is transmitted to the digital television receiving device 200, and in accordance with that command, the CPU 208 of the digital television receiving device 200 controls the picture/audio decoder unit 203, and performs switch control for whether to write to the picture/audio memory 204 while keeping the same image with a 16:9 aspect ratio or to write to the picture/audio memory 204 after converting to 4:3 by means of the processing of S1101 to S1103, the processing of S1111 to S1114, and the processing of S1201 to S1202, shown in FIG. 11.

Further, in the event that the user has specified the contents “F1 GRAND PRIX” by means of the processing of S501 to S504 and S511 to S513 in FIG. 5, playback begins for the contents with the ID number specified on the HDD recording device 110, by means of the processing of S505 to S507, the processing of S514 to S518 in FIG. 5, and the data illustrated in FIG. 15, and that picture/audio data is transmitted to the portable information terminal 102 via the digital television receiving device 200. Next, the video format “4:3”, and the information “multi-angle=‘available’” of the contents being transmitted to the portable information terminal 102 is obtained by means of the processing of S508 to S509, the processing of S519 to S520, and the processing of S1601 to 1603 of FIG. 16, and in accordance with the table data illustrated in FIG. 17, data called XML_B is selected as the XML data corresponding to “4:3 and multi-angle available”, and is sent to the portable information terminal. The received XML data is displayed on the portable information terminal 102 such as shown in FIG. 23B. Next, in the event that the user presses the [3] key while viewing and listening to contents, a “viewing and listening contents operation command” is transmitted to the digital television receiving device, and, in accordance with to that command, the digital television receiving device 200 changes the picture component to be played back, and instructs the demultiplexer 202 to play back pictures at other angles by means of the processing of S1101 to S1103, the processing of S1111 to S1114, and the processing of S1201 to S1202, shown in FIG. 11.

As described above, according to the third embodiment of the present invention, XML data for viewing and listening aid is sent with the contents to a portable information terminal 102, and in the event that a user presses one of the keys [1], [2], or [3] while viewing or listening, the desired operations can be performed regarding those contents. Further, the XML data for the viewing and listening aid to be transmitted is selected according to the contents broadcast form, that is to say, the video format and whether or not multi-view is used, and then is transmitted; accordingly, only the functions applicable to viewing and listening to the contents of that broadcast form are displayed to the user as a viewing and listening aid, and the operations can be performed.

For example, in the case of watching a 16:9 aspect ratio program on a display screen that is 4:3, a user may decide to watch the picture as it was intended even though blank spaces are shown on the top and bottom, or may wish to view a larger display even if it is elongated vertically, and may desire to switch between the two depending on the situation, but this is not necessary with a 4:3 program, and in fact, if the operation guide was arranged to display “SWITCH VIEW” on the liquid crystal display of the portable information terminal 102 in the case that the program is not a multi-view broadcast, the user might become confused as to what can be switched.

Because the operations performed on the contents by the user differ based on the broadcast form of the program in this manner, operations during viewing and listening can be easily performed even with limited buttons, by selecting XML data for viewing and listening aid to match the broadcast form of contents to be viewed and listened to, according to the present embodiment.

Further, in the case of displaying the operations guide while playing back contents on a liquid crystal display of small size, there is insufficient space to display text and graphics, and therefore a large number of guides cannot be displayed. Even in this situation, selecting the XML data having the script and guide display most suited to the broadcast form of the contents enables operations on the contents to be sufficiently performed, even with a guide display showing a limited number of functions, as illustrated in FIGS. 23A and 23B.

Fourth Embodiment

(Sending with BML Processing)

The television receiving system, the digital television receiving device therein, and the external diagram and construction of the portable information terminal are the same as the first embodiment; therefore, description thereof will be omitted here. Also, the present embodiment will be described under the assumption that multiple program contents such as that illustrated in FIG. 12 previously are accumulated in the HDD recording device 110. Moreover, of the programs in FIG. 15, for purposes of discussion here “SOCCER WORLD CUP” is a program with an aspect ratio of 16:9.

Operations of the television receiving system of the present embodiment are executed with an operational flow basically similar to that in the first embodiment, as illustrated in FIG. 5.

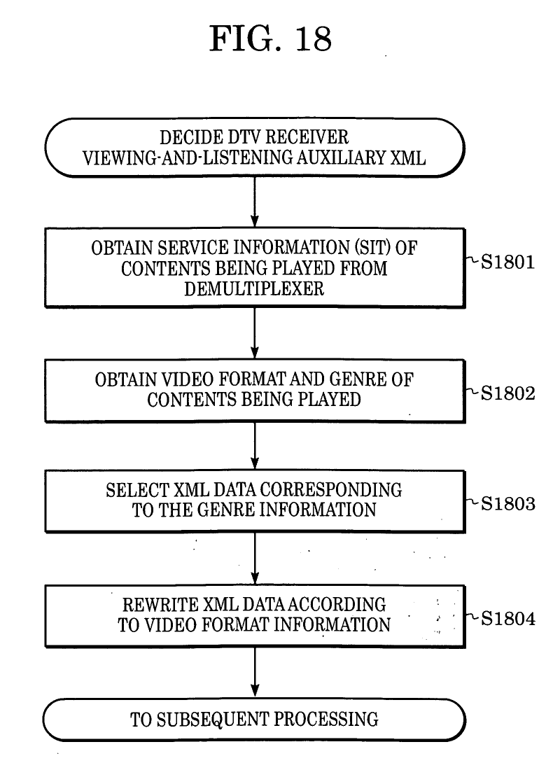

FIG. 18 is a flowchart further illustrating the processing wherein the CPU 208 of the digital television receiving device 200 selects XML data for viewing and listening aid (S519 in FIG. 5), according to the present embodiment. The CPU 208 of the digital television receiving device 200 makes a request to the demultiplexer unit 202 to obtain service information (S1801) of the program contents being transmitted to the portable information terminal 102 during data transmission to the portable information terminal 102 via the demultiplexer unit 202, the picture/audio decoder unit 203, the picture/audio memory 204, and the picture/audio encoder unit 209, wherein the data transmitted is from an external device, here the HDD recording device 110, via the IEEE 1394 serial bus. Once the service information is obtained, the genre information and video format information therein is extracted (S1802).

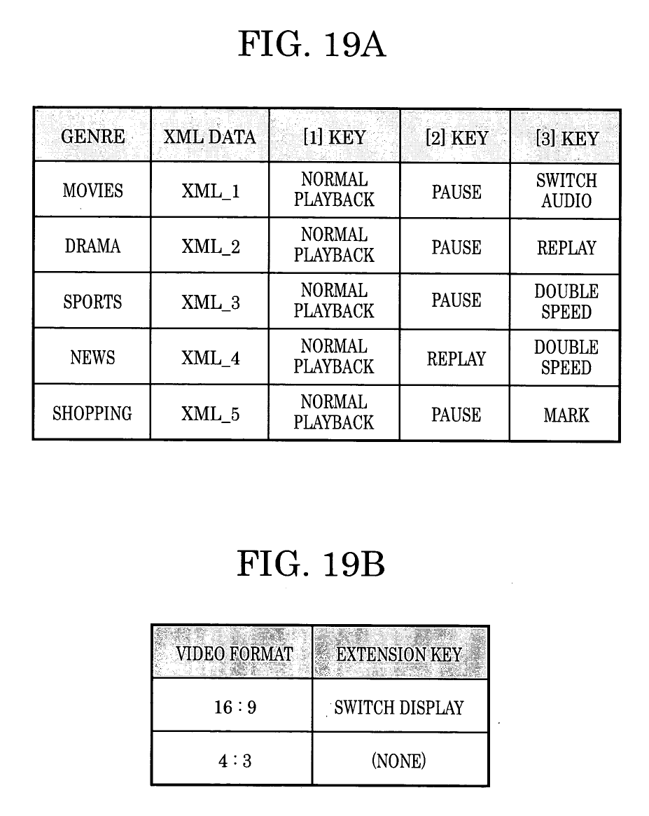

Upon obtaining the service information, the CPU 208 selects the XML data corresponding to the genre information of the program, according to the table illustrated in FIG. 19A (S1803). Further, the CPU 208 rewrites the XML data described corresponding to the video format information according to the table illustrated in FIG. 19B (S1804).

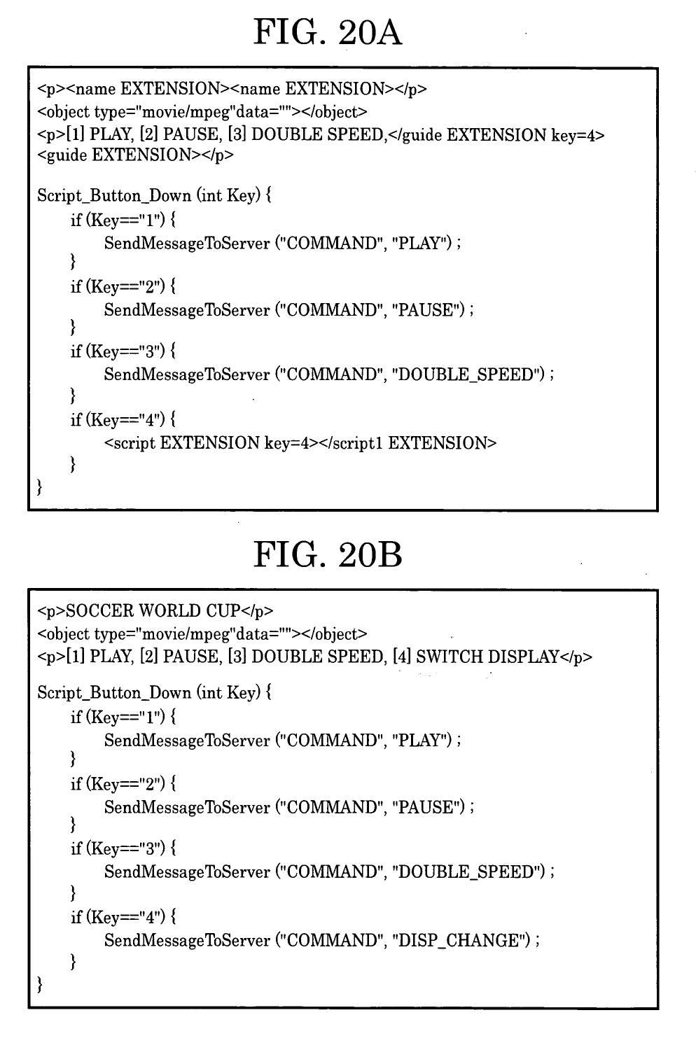

FIG. 20A illustrates the content of XML data corresponding to a program wherein genre =sports, at the point in time of selection at S1803. Herein, the portion shown as

<name EXTENSION></name EXTENSION>

<guide EXTENSION key=“4”></guide EXTENSION>

<script EXTENSION key=“4”></script EXTENSION>

indicates the locations to be rewritten, and the CPU 208 rewrites these areas with other characters, by means of S1804 processing. The <name EXTENSION></name EXTENSION> portion is the program title of contents to be rewritten, and the CPU 208 rewrites this portion based on the “program title” information from the service information obtained from the demultiplexer unit 202.

Further, the portions <guide EXTENSION key=“4”></guide EXTENSION> and <script EXTENSION key=“4”></script EXTENSION> are the portions to be rewritten according to the video format of the program contents, and if it is a 16:9 program, the table in FIG. 19B indicates that the function “SWITCH DISPLAY” is to be described as an extension, and rewriting processing is performed on the locations to be rewritten, and as a result, the XML data as shown in FIG. 20B is generated.

The following is a description of the operation results of the above processing.

In the event that the user has specified the contents “SOCCER WORLD CUP” by means of the processing of S501 to S504 and S511 to S513 in FIG. 5, the playback begins for the contents with the ID number specified on the HDD recording device 110, by means of the processing of S505 to S507, the processing of S514 to S518 in FIG. 5, and the data illustrated in FIG. 15, and that picture/audio data is transmitted to the portable information terminal 102 via the digital television receiving device 200. Next, the genre and video format=16:9 of the contents being transmitted to the portable information terminal is obtained by means of the processing of S508 to S509, the processing of S519 in FIG. 5, and the processing of S1801 to 1803 of FIG. 18, and IN ACCORDANCE WITH the table data illustrated in FIG. 19A, data called XML_1 is selected as the XML data corresponding to “SPORTS”. Then the CPU 208 writes the program title to the data called XML_1, and further writes the additional function of “SWITCH DISPLAY”, corresponding to the video format 16:9 in accordance with the table in FIG. 19B, and new XML data is generated. This XML data is sent to the portable information terminal 102.

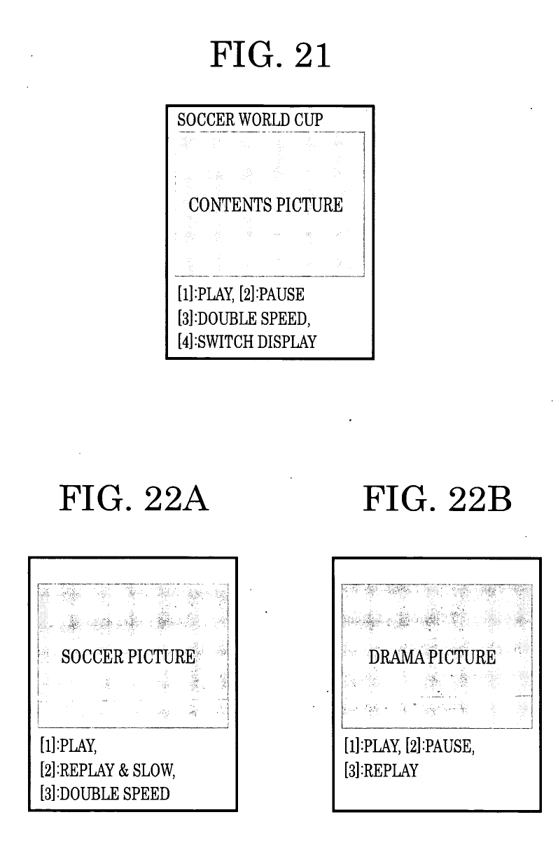

FIG. 21 is a diagram illustrating an example of the screen displaying received XML data, wherein the portable information terminal 102 is utilizing the browser application. The program title is written in the top portion of the figure, underneath this is the picture display area, and further under that the operation guide is displayed. Further, herein is displayed the additionally-written guide called “SWITCH DISPLAY”.

In the event that the user presses the [3] key while viewing and listening to contents, a “viewing and listening contents operation command” is transmitted to the digital television receiving device 200, and, in accordance with that command, the CPU 208 of the digital television receiving device 200 controls the picture/audio decoder unit 203, and performs switch control for whether to write to the picture/audio memory 204 while keeping the same image with a 16:9 aspect ratio or to write to the picture/audio memory 201 after converting to 4:3 by means of the processing of S1101 to S1103, the processing of S1111 to S1114, and the processing of S1201 to S1202, shown in FIG. 11.

As described above, according to the fourth embodiment of the present invention, XML data for viewing and listening aid is sent with the contents to a portable information terminal 102, and in the event that a user presses one of the keys [1], [2], or [3] while viewing or listening, the desired operations can be performed on those contents.

Further, new XML data is generated and transmitted to the portable information terminal 102 as XML data for the viewing and listening aid, taking the combination of the contents genre and broadcast form into consideration; therefore, only the functions applicable to viewing and listening to the contents of that genre and broadcast form are displayed to the user as a viewing and listening aid, and the operations can be performed.

Further, with the embodiments described above, the digital television receiving device 200 has been described as storing multiple XML data in advance, and selecting or changing a portion of one of those and transmitting the XML data to the portable information terminal 102. However, the essence of the present invention, wherein the most appropriate operation aid environment is selected and provided during viewing and listening to contents on the portable information terminal 102, is by no means limited to this arrangement. For example, an arrangement may be made wherein the digital television receiving device 200 can record only the URLs of the WWW server storing the multiple sets of XML data, and, after selecting the most appropriate XML data, send only that URL to the portable information terminal 102, with the portable information terminal 102 executing the XML data obtained from the WWW server on the browser application, based on the received URL.

In each embodiment described above, the application program has been described as using XML data as a viewing and listening aid. However, the essence of the present invention wherein the user is given operational aid during viewing and listening to contents on a portable information terminal, is by no means limited to this arrangement. Instead of XML data, multiple Java (a registered trademark) programs may be selected according to the accumulating device for the contents and transmitted to the portable information terminal, and the portable information terminal may operate a Java (registered trademark) environment instead of a browser application, and execute the Java (registered trademark) programs sent thereto.

Further, according to each embodiment described above, the number keys [1], [2], [3] and [4] of the portable information terminal were assigned functions and used as operations on the contents during viewing and listening, but the essence of the present invention is by no means limited to this arrangement; other keys can be used. Further, in the case that color keys are supplied, such as “red”, “green”, “yellow”, and “blue”, those can also be used.

As described above, according to the television receiving system and television receiving device according to the preferred embodiments, an operation aid environment appropriate to the type of recording device of viewing and listening contents is provided at the time of viewing and listening to program contents on a portable information terminal, and a guide is displayed to the user only for those operations that can be performed during viewing and listening; accordingly, even in the case that recording devices with differing functions listed exist in the system, an environment can be provided wherein operations can be performed easily during viewing and listening.

Further, an operation aid environment appropriate to the genre of viewing and listening contents is provided at the time of viewing and listening to program contents on a portable information terminal. For example, guides for operations used frequently can be displayed and executed according to the genre of contents, such as slow replay in the case of a sports program, and switching audio in the case of watching movies; therefore, operations can be easily performed even on portable equipment with limited buttons.

Further, an operation aid environment appropriate to the broadcast form of viewing and listening contents is provided at the time of viewing and listening to program contents on a portable information terminal. For example, an operation environment can be provided wherein operations necessary for the broadcast form of the contents are collected, and the operation “SWITCH DISPLAY” is displayed on the guide and process is enabled only when viewing and listening to a 16:9 program, and further, the operation “SWITCH VIEW” is displayed on the guide and process is enabled only when viewing and listening to a multi-view program. In this manner, operations can be easily performed even on portable equipment with limited buttons.

Further, only functions which are to be used or which are available, according to the contents being viewed and listened to, are displayed on the guide; therefore, the problem wherein too much guide display takes up the screen space from the limited viewing space can be prevented.

According to the television receiving device and television receiving system according to the present invention, at the time of viewing and listening to program contents on a portable information terminal, the operation aid application appropriate to the types or functionality of the recording/playback equipment storing the contents, or the genre of the contents being played and listened to, is transmitted to the portable information device, and an operation environment can be provided that is appropriate for the viewing and listening situation.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A multimedia receiving device, comprising:
a contents input unit that receives contents data input from multiple connected external devices;
a contents transmission unit that transmits input contents data to a terminal device;
a storing unit that stores multiple application programs corresponding to the types of multiple connected external devices; and
an application transmission unit that transmits an application program, selected from the multiple application programs, based on the types of multiple connected external devices, to the terminal device.

2. A multimedia receiving device according to claim 1, further comprising:
a decoding unit that decodes the input contents data into picture/audio data; and
an encoding unit that encodes the picture/audio data decoded by said decoding unit using an appropriate encoding method corresponding to the terminal device,
wherein said contents transmission unit transmits data supplied from said encoding unit to the terminal device.

3. A multi-media receiving device according to claim 1, wherein the external device is a digital VTR device, a disk recording device, or the like, and
wherein said terminal device is a display terminal device capable of displaying images.

4. A multi-media receiving device according to claim 3, wherein the application program is executed upon playing the contents on the display terminal device, and processing for a display layout and user operation is described therein.

5. A multi-media receiving device according to claim 4, wherein said application transmission unit selects an application program which includes a function to perform special playback in the case that the external device is a disk recording device, and an application program which does not include a function to perform special playback in the case that the external device is a digital VTR device.

6. A multi-media receiving device comprising:
a recorded contents input unit that receives contents data supplied from a recording/playback device;
a broadcast contents input unit that receives digital broadcast contents data;
a contents transmission unit that transmits input contents data to the terminal device;
a storing unit that stores multiple application programs corresponding to each of the recorded contents and broadcast contents; and
an application transmission unit that transmits to the terminal device an application program selected from the multiple application programs, based on whether the contents data is recorded contents or broadcast contents.

7. A multi-media receiving device comprising:
a contents input unit that receives contents data;
an attributes obtaining unit that obtains attributes of input contents data;
a contents transmission unit that transmits the input contents data to a display terminal device;
a storing unit that stores multiple application programs;
an application transmission unit that transmits the multiple application programs to the display terminal device an application transmission unit that transmits to the display terminal device an application program selected from the multiple application programs, based on contents attributes.

8. A multi-media receiving device according to claim 7, further comprising:
a decoding unit that decodes the contents data into picture/audio data; and
an encoding unit that encodes the picture/audio data decoded by said decoding unit using an appropriate encoding method corresponding to the display terminal device,
wherein said contents transmission unit outputs data supplied from said encoding unit to the display terminal device.

9. A multi-media receiving device according to claim 7, wherein the contents attributes are genre classifications such as sports, news, dramas, shopping, movies, and the like.

10. A multi-media receiving device according to claim 7, wherein the contents attributes are broadcast attributes of contents such as picture format information, multi-view information, and the like.

11. A multi-media receiving device according to claim 7, wherein the application programs are executed upon playing the contents on the display terminal device, and processing for a display layout and user operation is described therein.

12. A multi-media receiving device according to claim 7, wherein said application transmission unit processes the application programs stored in said storing means, based on the contents attributes obtained by said contents attribute obtaining unit, and transmits the processed application program to the display terminal device.

13. A multi-media receiving system comprising:
a multi-media receiving device;
a display terminal device that performs data exchange with said multi-media receiving device via a network; and
a recording/playback device connected to said multi-media receiving device;
said multi-media receiving device comprising:
a broadcast contents receiving unit that receives broadcast contents,
an accumulated contents input unit that receives contents data from said recording/playback device,
a contents transmission unit that transmits broadcast contents or accumulated contents data to said display terminal device, in accordance with instructions from said display terminal device,
a storing unit that stores multiple application programs, and
an application transmission unit that transmits to said display terminal device an application program selected from the multiple application programs, according to whether the contents being transmitted to said display terminal device are broadcast contents or contents input from said recording/playback device; and
said display terminal device comprising:
a receiving unit that receives contents data transmitted from said multi-media receiving device,
a contents playback unit that plays back the received contents data,
a display unit that displays picture data, and
an application execution unit that executes an application program that is transmitted from said multi-media receiving device simultaneously with the contents playback.

14. A multi-media receiving system according to claim 13, wherein said display terminal device comprises a user input,
wherein the application program includes processing to execute transmission of commands to said television receiving device based on input information from said user input; and
wherein said television receiving device comprises a playback control unit that controls playback operations of said recording/playback device, in accordance commands received from said display terminal device.

15. A multi-media receiving system according to claim 13, wherein said multi-media receiving device is connected to multiple recording/playback devices of different types and having different function attributes, and
wherein said application transmission unit transmits the application program selected from the multiple application programs to said display terminal device, in accordance with the types and function attributes of said recording/playback devices, in the case that the contents being transmitted to said display terminal device are the accumulated contents from the recording/playback device.

16. A multi-media receiving system comprising:
a multi-media receiving device;
a display terminal device that performs data exchange with said multi-media receiving device via a network; and
a recording/playback device that is connected to said multi-media receiving device,
said multi-media receiving device comprising:
a broadcast contents receiving unit that receives broadcast contents data,
an accumulated contents input unit that receives contents data input from said recording/playback device,
a contents attributes obtaining unit that obtains the attributes of the input contents data,
a contents transmission unit that transmits broadcast contents data or accumulated contents data, corresponding to the instructions from said display terminal device, to said display terminal device,
a storing unit that stores multiple application programs, and
an application transmission unit that selects one of the multiple application programs, based on the contents attributes obtained by said contents attribute obtaining unit, and transmits the one application program to said display terminal device; and
said display terminal device comprising:
a receiving unit that receives contents data transmitted from said multi-media receiving device,
a contents playback unit that plays back the received contents data,
a display unit that displays picture data, and
an application execution unit that executes an application program that is transmitted from said multi-media receiving device simultaneously with the contents playback.

17. A multi-media receiving system according to claim 16, wherein said display terminal device has a user input,
wherein the application program includes processing to execute transmission of commands to said multi-media receiving device based on input information from said user input, and
wherein said multi-media receiving device comprises a playback control unit that controls playback operations of said recording/playback device, in accordance with commands received from said display terminal device.

18. A multi-media receiving system comprising:
a multi-media receiving device;
a recording/playback device connected to said multi-media receiving device;
a display terminal device that performs data exchange via a network with said multi-media receiving device; and
an application program server that performs data exchange via a network with said display terminal device;
said multi-media receiving device comprising:
a broadcast contents receiving unit that receives digital broadcast contents,
an accumulated contents input unit that receives accumulated contents data from said recording/playback device,
a contents attributes obtaining unit that obtains attributes of the input contents data,
a contents transmission unit that transmits to said display terminal device broadcast contents data or accumulated contents data, corresponding to the instructions from said display terminal device,
a storing unit that stores a network address wherein multiple application programs are stored, and
an application address transmission unit that selects one of the multiple application programs, based on the contents attributes obtained by said contents attribute obtaining unit, and transmits the network address of the application program corresponding to said display terminal device; and
said display terminal device comprising:
a receiving unit that receives contents data transmitted from said multi-media receiving device,
a contents playback unit that plays back the received contents data,
a display unit that displays picture data, and
an application execution unit that executes an application program simultaneously with the contents playback, wherein the application program is obtained from said application server, based on the network address of the application program transmitted from said multi-media receiving device.
